(19) United States
(12) Patent Application Publication
(10) Pub. No.: US 2014/0060445 A1
(43) Pub. Date: Mar. 6, 2014

(54) Animal safety cages for temporarily retaining pets of business customers, and automated system for animal safety cages

(71) Applicant: Jennifer Wilms, Lakewood, OH (US)

(72) Inventor: Jennifer Wilms, Lakewood, OH (US)

(21) Appl. No.: 13/987,695

(22) Filed: Aug. 21, 2013

Related U.S. Application Data
(60) Provisional application No. 61/743,085, filed on Aug. 27, 2012.

(51) Int. Cl. A01K 1/03

(52) U.S. Cl. CPC A01K 1/03
USPC 119/481

(57) ABSTRACT

An animal safety cage includes a locking mechanism to secure a door of the cage to prevent escape or kidnapping of an animal placed within. The locking mechanism may accept and verify identifying information of a person seeking to temporarily place an animal within the enclosure, and may conditionally allow the person to do so based on the result of the verification. While the animal is placed within the enclosure, the identifying information may be used to transmit reminder messages and/or charge fees to induce the person to retrieve the animal within a reasonable period of time. Either a captive key or further verification of identifying information may be used to conditionally allow subsequent retrieval of the animal.

### REFERENCE TO PROVISIONAL APPLICATION

This Utility Application claims the benefit of the filing date of Provisional Application Ser. No. 61/743,085 filed Aug. 27, 2012 entitled TEMPORARY ANIMAL SAFETY CAGE FOR BUSINESS CUSTOMERS (Atty's Docket 6-829), the disclosure of which is incorporated herein by reference.

### BACKGROUND

The present application relates to the provision and management of a cage that can be used to safely retain one's pet while a person is visiting or shopping in a business. More particularly, the present application relates to the provision of one or more lockable cages that typically are situated near the entry of a business establishment for safely, conveniently and reliably temporarily sheltering pets that are the responsibility of persons who patronize the business establishment. Also disclosed are features and options that may be incorporated in a system used to operate, control, manage and maintain the cages.

Pet owners who choose to patronize businesses while walking or traveling with their pets often find that their pets are unwelcome inside business establishments. Some choose to tie their pets on leashes to sign posts, bicycle racks or other stationary objects located near the entrances of businesses. Others face the dilemma of whether to leave a pet inside a vehicle, which can present safety concerns, and may violate local or state ordinances.

Even in business establishments that permit the entry of pets, a variety of problems may arise such as pets becoming frightened by other pets, disruptive pet behavior, or inappropriate pet attention given by children—which may result in children getting bit.

### SUMMARY

What is disclosed in the present application addresses these and other problems and concerns by offering 1) well constructed yet relatively inexpensive animal safety cages that are well suited to be provided by business establishments for safely temporarily retaining pets (e.g., animals such as cats or dogs, not shown) that are in the custody of those who visit the businesses, and 2) system features and options for managing, controlling, operating and maintaining the animal safety cages. Various embodiments address the needs of pet owners who are walking or traveling with pets for animal safety cages in which pets can be individually safely temporarily sheltered while pet owners enter and patronize business establishments.

In preferred practice, care is taken to ensure that safety cages which are provided by businesses for temporarily housing customers' pets are provided with locking mechanisms that are well suited to retain pets, to prevent escape of pets, and to prevent pets from being taken by persons other than the persons who authorized placement of pets in the cages.

In preferred practice, care is taken to ensure that animal safety cages that are provided for temporarily sheltering pets are adequately ventilated to prevent pets from becoming overheated.

In preferred practice, care is taken to ensure that adequate identification is obtained from persons who place pets in animal safety cages to ensure that only authorized persons are permitted to withdraw the pets from the animal safety cages.

In preferred practice, care is taken to ensure that adequate identifying information is obtained from persons who place pets in animal safety cages to ensure that the animal safety cages are not used as tools to abandon unwanted pets.

In preferred practice, animal safety cages are provided with a means for signaling persons who are entrusted with a duty to maintain animal safety cages that attention is needed to a particular animal safety cage, and/or to a pet housed in a particular animal safety cage.

In preferred practice, a waste bag holder or dispenser is provided in or on an installation of one or more animal safety cages so persons who utilize a particular cage can dispose of excrement or the like when found to be present.

In preferred practice, a waste bag holder or dispenser is positioned inside the animal safety cage or is operable only when a cage has been unlocked—such as when an animal is being placed within the cage or is being retrieved from the cage—to assure that a proper supply of waste bags is maintained and kept available, and the bags are not subjected to theft or misuse.

In preferred practice, an animal safety cage provided with a waste bag holder or dispenser is also provided with a monitor to detect depletion of a supply of waste bags, and may additionally act to signal when the supply is depleted, and/or to secure the cage against further use until the supply is replenished.

In preferred practice, an animal safety cage may be provided with various sensors for detecting and signaling the onset of inappropriate conditions that render an animal safety cage unsuited for continued use until attention is given to the cage, and/or for securing the cage against further use until appropriate attention has been given to the cage.

To encourage those who confine pets in the cages to remember to retrieve their pets, and to ensure that the cages are not misused as a dumping facility or place to abandon pets, the locking mechanisms provided on the cages may function as components of an automated kenneling system that requires identifying information to be provided before permitting persons to place their pets within the cages. The identifying information required to be provided may include financial information accompanied by authorization to charge fees to persons who make use of the cages in accordance with the amount of time during which pets are left in the safety cages.

Alternatively, or additionally, the identifying information that must be provided to open and permit use of a particular animal safety cage may include information that can be used to contact the person who makes use of a particular cage to remind them to retrieve their pet, or to contact appropriate authorities in situations in which pets are left in animal safety cages for longer than a set period of time.

### BRIEF DESCRIPTION OF THE DRAWINGS

A fuller understanding of what is disclosed in the present application may be had by referring to the description and claims that follow, taken in conjunction with the accompanying drawings, wherein:

FIG. 1 is a perspective view of an exterior of an animal safety cage provided with a locking mechanism for permitting and preventing opening of a hinged closure of the cage, with the view schematically depicting a waste bag dispenser and a waste tray that preferably are associated with the cage;

FIG. 2 is perspective view on an enlarged scale of the locking mechanism of FIG. 1, with the view also showing a strike than can be engaged by a spring-projected bolt of the locking mechanism, a card-shaped identification device carrying identifying information that can be read by the locking mechanism, and a captive key that can be inserted into a lock cylinder of the locking mechanism;

FIG. 3 is a block diagram of one embodiment of a kenneling system employing an embodiment of the animal safety cage of FIG. 1, showing aspects of interactions between the locking mechanism of FIGS. 1 and 2, and a server via a network;

FIG. 4 is a block diagram depicting further aspects of the embodiment of FIG. 3, showing aspects of interactions between the server of FIG. 3 and other computing devices via the network of FIG. 3;

FIG. 5 is a block diagram, similar to FIG. 3, of another embodiment of a kenneling system employing another embodiment of the animal safety cage of FIG. 1;

FIG. 6 is a block diagram of an operating environment of an embodiment of the locking mechanism of either FIG. 3 or FIG. 5;

FIG. 7 is a block diagram of an operating environment of an embodiment of the server of either FIG. 3 or FIG. 5.

FIG. 8 is a flow chart of logic implemented by an embodiment of the animal safety cage of FIG. 1 to monitor and respond to the level of a supply of waste bags;

FIG. 9 is a flow chart of logic implemented by an embodiment of the animal safety cage of FIG. 1 to determine whether to allow an animal to be placed in the cage based on verification of identifying information;

FIG. 10 is a flow chart of logic implemented by an embodiment of the server of either FIG. 3 or FIG. 5 to monitor an elapsing of time during which an animal is within an animal safety cage, and signal one or more persons in response;

FIG. 11 is a flow chart of logic implemented by an embodiment of the animal safety cage of FIG. 1 to determine whether to allow an animal to be retrieved from the cage based on verification of identifying information; and

FIG. 12 is a block diagram of an example processing architecture that may be employed by an embodiment of the animal safety cage of FIG. 1 and/or by an embodiment of the server of either FIG. 3 or FIG. 5.

### DETAILED DESCRIPTION

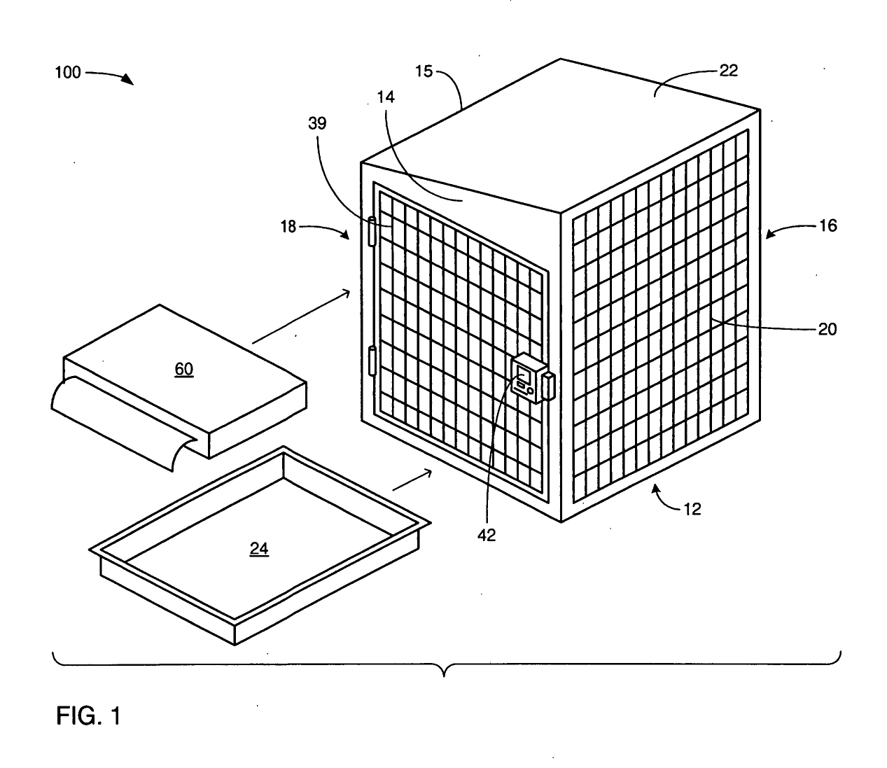

Referring to FIG. 1, an embodiment of an animal safety cage for use in temporarily holding an animal (e.g., a pet such as a cat, dog, or other animal of similar shape or size) while a person patronizes a business is indicated generally by the numeral 100. The animal safety cage 100 includes an enclosure 15 to which a locking mechanism 42 is attached to selectively lock a door 39 of the enclosure 15. The animal safety cage 100 may be positioned either within the premises of a business or outside near an entrance as a service provided by that business to patrons who are accompanied by pets. The animal safety cage 100 may be owned and operated by that business, or may be owned an operated by a service contracted with by that business.

The enclosure 15 may be of a generally rectangular shape, although the enclosure 15 may be provided with a roof 22 of a peaked or slanted configuration. As depicted, the enclosure 15 includes a front wall 14 that defines an opening 34 that is selectively closable by the door 39, and a rear wall 16 on a side opposite the front wall 14. The enclosure 15 also includes opposing side walls 18 and 20 that extend between the front wall 14 and the rear wall 16, and a floor 12. It is preferred that at least one of the walls 14, 16, 18 or 20, and/or the door 39 be formed from a metal mesh, metal wire or other structure resistant to corrosion and to chewing by animals, and that also provides substantial ventilation to permit a relatively free flow of air into and/or through the enclosure 15 to enable an animal placed within to remain relatively cool during a day of hot temperatures. In some embodiments, the roof 22 is formed of a solid piece of material with few or no openings formed therethrough to protect an animal placed within the enclosure 15 from inclement weather, such as rain in installations in which the animal safety cage 100 is positioned outdoors.

The floor 12 may be formed of a mesh, wire or a solid piece of material with few or no openings formed therethrough. A tray 24 may be placed atop the floor 12 within the enclosure 15, or may be otherwise suitably positioned to catch excrement left by an animal placed within. The tray 24 may be shaped and/or sized to be relatively easily removable to be cleaned or exchanged for another clean tray by persons making use of the animal safety cage 100 to facilitate and/or encourage some degree of effort by those persons to remove excrement left by animals placed within the enclosure 15.

A waste bag holder 60 may be disposed within the enclosure 15 to dispense waste bags and/or liners for the tray 24 to facilitate and encourage cleanliness efforts by pet owners. In some embodiments, the waste bag holder 60 may be placed within the enclosure 15 at a location suspended just below the roof 22 and behind the door 39 to protect the supply of waste bags and/or liners from exposure to inclement weather and/or theft, or may be otherwise suitably positioned.

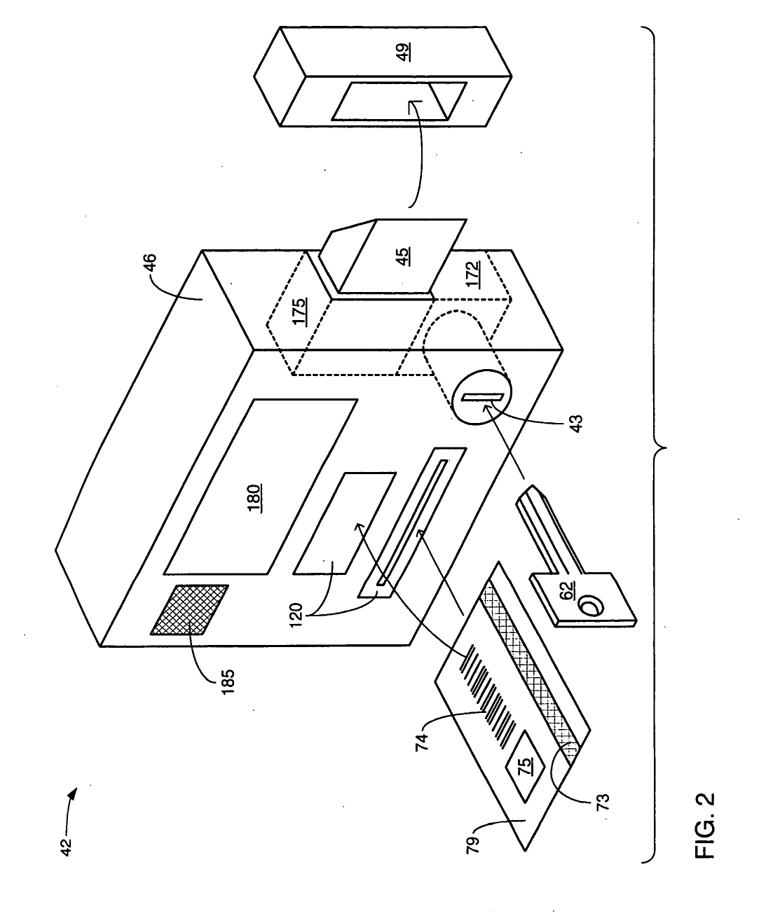

The locking mechanism 42 is mounted on the door 39 and preferably has a spring-projected bolt 45 that engages and is retrained by a strike 49 when the door 39 is closed. The strike 49 is mounted on the front wall 14. Referring to FIG. 2, the locking mechanism 42 includes a housing unit 46 on which may be disposed a display 180 and/or speaker 185, one or more input devices 120 and/or a lock cylinder 43 in a manner accessible from the exterior of the housing unit 46. Disposed within the housing unit 46 may be a bolt actuator 175 operable to extend and/or retract the bolt 45 from within the housing unit 46 to selectively engage the strike 49 to selectively lock the door 39 in a closed position to substantially close the opening 34 formed through the front wall 14 and retain an animal within the enclosure 15.

Various possible embodiments of the locking mechanism 42 may incorporate different types or different combinations of types of input device(s) 120 to accept identifying information stored in one or more types of an identification device 79 that may be carried by a person seeking to temporarily place an animal within the enclosure 15. As depicted, the identification device 79 may take the form of a card that may be of a shape and size comparable to typical credit cards. Indeed, such a card-shaped identification device 79 may be a credit card, a automatic teller machine (ATM) card, a driver's license, a corporate identification card, a business loyalty program card or any of a variety of other types of cards on which is stored identifying information. Depending on the type of identification device 79, such identifying information may be stored in a magnetic stripe 73, a barcode 74 and/or a wirelessly accessible chip 75 of the identification device 79. Corresponding to the technology used by whatever form of the identification device 79 is accepted for use with a particular embodiment of the locking mechanism 42, the one or more input devices 120 may include a magnetic stripe reader, a barcode scanner, a radio frequency (RF) and/or magnetic transceiver, and/or infrared (IR) transceiver.

Despite the specific depiction of a card-shaped form of identification device 79, and despite the depiction of specific examples of technologies to store identifying information, still other forms of an identification device will occur to those skilled in the art. By way of example, an alternate form of the identification device 79 may be key fob or radio frequency identification (RFID) tag device employing RF and/or magnetic wireless communications to convey identifying information. By way of another example, an alternate form of the identification device 79 may be a smart phone or other portable computing to determine whether to allow an animal (e.g., a pet such as a cat or dog) to be placed within the enclosure 15 of the animal safety cage 100, to monitor the amount of time during which an animal is placed therein, and to induce a person placing an animal within the enclosure 15 to retrieve the animal therefrom within a reasonable period of time.

Not unlike the animal safety cage 100, itself, the kenneling system 1000 into which the animal safety cage 100 is incorporated may be owned and/or operated by a business at which or near which the animal safety cage 100 is positioned. Alternatively or additionally, the kenneling system 1000 may be owned and/or operated by another service entity with which that business has entered into a contract to provide the services of the animal safety cage 100 at or within that business as a convenience for patrons. Further, although only a single animal safety cage 100 is depicted and discussed herein, installations at or within a business may include multiple ones of the animal safety cage 100, each of which interacts with the server 300 as is about to be described in detail.

As depicted, the locking mechanism 42 may be implemented at least partly as a computing device incorporating one or more of a processor component 150, a storage 160 and an interface 190. The locking mechanism 42 also incorporates one or more of an occupancy detector 110, a key detector 112, a closure detector 113, at least one input device 120, the key release 172, the bolt actuator 175, a lock restrictor 177, the display 180, the speaker 185 and an interface 190. Further, the locking mechanism 42 may be coupled to a waste bag detector 116.

The occupancy detector 110 detects whether an animal is currently within the enclosure 15 to determine whether the animal safety cage 100 is currently in an occupied or unoccupied state of occupancy. The occupancy detector 110 may be device that displays a barcode or other symbol conveying identifying information and/or engages in RF or IR wireless communications to convey identifying information.

The display 180, if present, may present visual prompts to a pet owner of what to do to make use of the animal safety cage 100. Alternatively or additionally, the speaker 185, if present, may present audible prompts based on either a recorded or synthesized voice.

The lock cylinder 43, if present, may receive a conventional key 62, and may serve as storage for the key 62 (if held captive in the lock cylinder 43) until released under the control of a key release 172 to a person seeking to temporarily place an animal (e.g., a pet such as a cat, a dog or another animal of similar shape and/or size) within the enclosure 15. On occasions where the key 62 has been released to the possession of a person who has placed an animal within the enclosure 15, the lock cylinder 43 may accept a master key (not shown) in the possession of an operator of a business in the vicinity of the animal safety cage 100 to unlock the locking mechanism 42 to permit opening of the door 39. The provision of such a master key may be deemed desirable where automated functions of the locking mechanism 42 have failed (e.g., during a power failure or a malfunction) such that the door 39 is otherwise unable to be opened, or in situations in which the health of the animal placed within is in question or jeopardy.

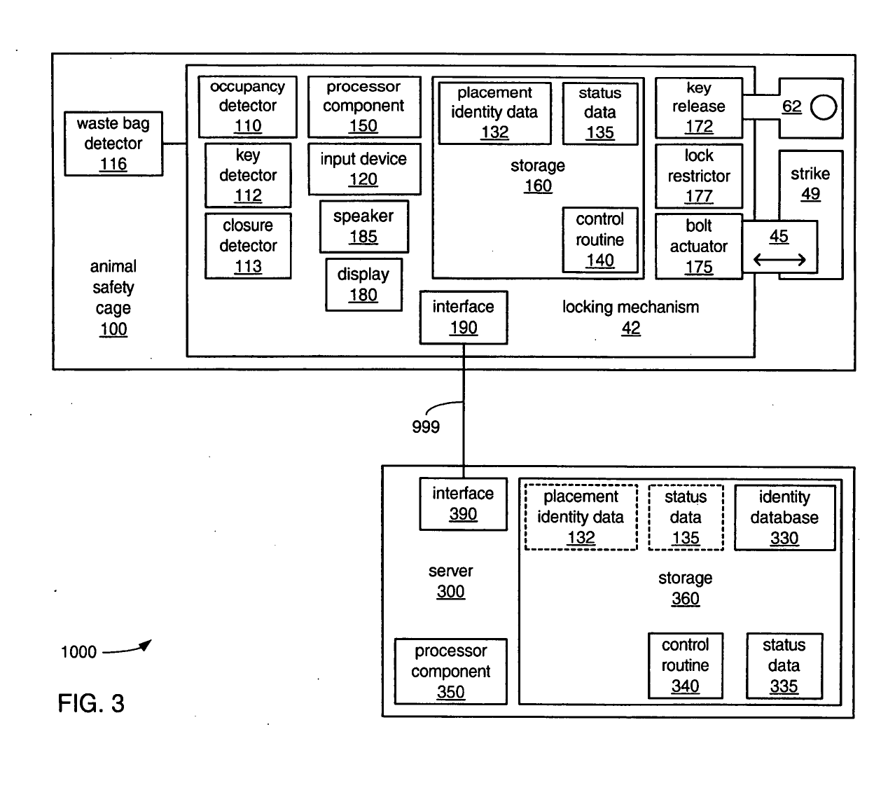

Referring to FIG. 3, the animal safety cage 100 may be incorporated into an embodiment of an automated kenneling system indicated generally by the numeral 1000. Also incorporated into the automated kenneling system 1000 is at least one server 300 coupled to the locking mechanism 42 by a network 999. As will be explained in greater detail, the locking mechanism 42 cooperates with at least the server 300 through the network 999 incorporated into the housing unit 46 of the locking mechanism 42 in a manner in which the occupancy detector 110 is provided access to the environment within the enclosure 15 to detect the presence of an animal placed within. Alternatively, the occupancy detector 110 may be disposed within the interior of the enclosure 15. The occupancy detector 110 may be based on any of a variety of technologies for detecting the presence of an animal, including and not limited to, detecting body heat, motion or sounds emanating from an animal placed within the enclosure 15.

The closure detector 113 detects whether the door 39 of the enclosure 15 is currently in an open or closed state. The closure detector 113 may be incorporated into the housing unit 46 of the locking mechanism 42 in a manner in which the closure detector 113 is provided access to a portion of the enclosure 15 other than the door 39 to detect whether the door 39 is open or closed. Alternatively, the closure detector 113 may be disposed on a portion of the enclosure 15. The closure detector 113 may be based on any of a variety of technologies for detecting the state of the door 39, including and not limited to, a magnetic switch, an optical switch, a proximity detector or mechanical switch.

The key detector 112 detects whether the key 62 is currently inserted into the lock cylinder 43. The key detector 112 may be based on any of a variety of technologies for detecting the presence or absence of the key 62 in the lock cylinder 43, including and not limited to, a mechanical switch or an optical switch.

The waste bag detector 116, if present, monitors the state of a supply of waste bags provided by the waste bag holder 60 to detect whether that supply is becoming low and/or has been entirely depleted. The waste bag detector 116 may be disposed within the enclosure 15 in embodiments in which the waste bag holder 60 is also disposed within the enclosure 15. The waste bag detector 116 may be based on any of a variety of technologies to monitor a supply of waste bags, including and not limited to, an optical sensor.

As previously discussed, the bolt actuator 175 moves the bolt 45 into and/or out of engagement with the strike 49 to at least selectively lock the door 39 in a closed state. As also previously discussed, the key release 172 selectively releases the key 62 to the possession of a person who temporarily places an animal within the enclosure 15. The lock restrictor 177 selectively prevents use of the key 62 to operate the lock cylinder 43 to unlock the door 39. The bolt actuator 175, the key release 172 and the lock restrictor 177 may each be based on any of a variety of technologies, including and not limited to, a linear motor or a rotary motor.

As previously discussed, the display 180 and/or the speaker 185 may present prompts to a pet owner to guide them in using the animal safety cage 100. The display 180 may be based on any of a variety of display technologies, including and not limited to, cathode ray tube (CRT), liquid crystal display (LCD), electroluminescent (EL), or plasma. The speaker 185 may be based on any of a variety of technologies, including and not limited to, an electromagnetic acoustic driver or a piezo-electric acoustic element.

As previously discussed, there may be one or more input devices 120, each employing a different technique to obtain identifying information from one or more identifying devices 79. Again, such techniques may include one or more of receiving RF and/or magnetic signals, receiving IR signals, optically scanning barcodes, or any of a variety of other possible techniques by which data may be received.

The interface 190 couples the locking mechanism 42 to the network 999 to enable communication with at least a server 300. The network 999 may be any of a variety of types of network (or a combination of types of network), including and not limited to, a wired or wireless local area network (LAN) extending within a structure, a wide area network (WAN) extending among multiple structures, or the Internet. The network may be based on any of a variety of wired or wireless technologies (or any of a variety of possible combinations of wired and wireless technologies), including and not limited to, electrically conductive cabling, fiber optic cabling, RF signaling or IR signaling.

The storage 160 stores one or more of a control routine 140, placement identity data 132 and status data 135. The control routine 140 incorporates a series of instructions implementing logic, that when executed by the processor component 150, cause the processor component 150 to perform functions described herein.

In some embodiments, in executing the control routine 140, the processor component 150 monitors the waste bag detector 116 to recurringly determine an amount of waste bags remaining in the waste bag holder 60. In response to the remaining amount of waste bags falling beneath a predetermined level, the processor 150 may operate the interface 190 to signal the server 300 via the network 999 with an indication of such a low level. In turn, the server 300 may signal personnel (e.g., by email, a phone call with a synthesized voice, or text message to a portable device carried by personnel) with an indication of the low level of waste bags remaining. Alternatively or additionally, in response to depletion of the waste bags dispensed by the waste bag holder 60, the processor component 150 may operate the display 180 and/or the speaker 185 to present an indication that the animal safety cage 100 is unavailable for use until the supply of waste bags is replenished. The transmission to the server 300 may include a transmission of the status data 135, which may include an indication of the amount of waste bags remaining and/or of the processor component 150 acting to prevent further use of the enclosure 15 until the supply of waste bags is replenished.

Alternatively or additionally, in executing the control routine 140 at a time when the key 62 is held captive in the lock cylinder 43 and the enclosure 15 is not already occupied by an animal, the processor component 150 maintains the animal safety cage 100 in a secured state in readiness for use in which the door 39 is locked and the lock restrictor 177 is operated to prevent use of the key 62 to operate the lock cylinder 43 to unlock the door 39. The processor component 150 monitors the input device(s) 120 for an indication of receipt of identifying information from an identification device 79 of a person seeking to place an animal within the enclosure 15. Upon receiving an indication of at least an attempt to provide identifying information by such a person, the processor component 150 may operate the display 180 and/or the speaker 185 to prompt the person as to what types of identifying devices 79 (or combinations of identifying devices 79) are required.

Upon receiving at least a predetermined combination of pieces of identifying information from one or more identification devices 79 provided by that person, the processor component 150 stores the identifying information as the placement identity data 132. What pieces of identifying information make up the predetermined combination of pieces of identifying information may differ among different embodiments of the animal safety cage 100 and/or of the automated kenneling system 1000, as will be explained more fully.

The processor component 150 then operates the interface 190 to transmit at least a portion of the placement identity data 132 to the server 300 for verification. If the server 300 indicates that the identifying information contained in the placement identity data 132 cannot be verified, then the processor component 150 may operate the display 180 and/or the speaker 185 to indicate to the person that they are denied use of the animal safety cage 100. Further, the processor component 150 refrains from operating the bolt actuator 175, the lock restrictor 177 and the key release 172 to either unlock the door 39 or release the key 62 to the person.

However, if the server 300 indicates that the identifying information contained in the identity data 132 is verified, then the processor component 150 operates the bolt actuator 175 to unlock the door 39 to allow the person to place an animal within the enclosure 15 and operates the key release 172 to grant possession of the key 62 to that person. The processor component 150 monitors the occupancy detector 110, the closure detector 115 and the key detector 112 to detect whether or not the person opens the door 39 to place an animal within the enclosure 15 or takes the key 62 out of the lock cylinder 43. The processor component 150 may operate the bolt actuator 175 to re-lock the door 39 to maintain the door 39 in a closed state and operate the key release 172 to retain the key 62 in the lock cylinder 43 against being removed therefrom if the person does not open the door 39 or take the key 62 within a predetermined period of time. This may be done based on a presumption that the person has changed their mind about placing an animal within the enclosure 15 if they have not either opened the door 39 or taken the key 62 within the predetermined period of time.

However, if the processor component 150, through monitoring the occupancy detector 110, the closure detector 115 and the key detector 112, determines that the person has opened the door 39 to placed an animal within the enclosure 15 or has taken the key 62, then the processor component 150 operates the bolt actuator 175 to re-lock the door 39 and operates the lock restrictor 177 to allow the key 62 to be later used to unlock the door 39 upon detecting that the door 39 has subsequently been closed with an animal placed within the enclosure 15. The processor component 150 then notes the placement of an animal within the enclosure 15 in the status data 135. The processor component 150 may recurringly provide at least a portion of the status data 135 to the server 300 to enable centralized monitoring of the current state of numerous ones of the animal safety cage 100 by the server 300.

While the enclosure 15 remains occupied by an animal placed within it, the processor component 150 monitors the key detector 112, the closure detector 113 and the occupancy detector 110 for indications of the key 62 being inserted into the lock cylinder 43, the door 39 being opened and the animal being retrieved from within the enclosure 15. Upon detecting such retrieval of the animal from within the enclosure 15 and the door 39 subsequently being closed with no animal occupying the enclosure 15, the processor component 150 operates the lock restrictor 177 to disallow further operation of the key 62 within the lock cylinder 43 to again unlock the door 39. The processor component 150 may also operate the bolt actuator 175 to lock the door 39 in the closed state and operate the key release 172 to retain the key 62 within the lock cylinder 43. Thus, the animal safety cage 100 is returned to a secured and unoccupied state in which it is again ready for use.

Also in response to such retrieval of an animal, the processor component 150 stores an indication in the status data 135 of the animal having been retrieved from within the enclosure 15, and again transmits the status data 135 to the server 300 to indicate the retrieval of the animal to the server 300.

The server 300 may be implemented as a computing device incorporating a processor component 350, a storage 360 and/or an interface 390. The storage 360 stores one or more of a control routine 340, the placement identity data 132 and/or the status data 135 received from the locking mechanism 42, and an identity database 330. The control routine 340 incorporates a series of instructions implementing logic, that when executed by the processor component 350, cause the processor component 350 to perform various functions described herein.

In some embodiments, in executing the control routine 340, the processor component 350 monitors the interface 390 for receipt of a signal from the locking mechanism 42 of the animal safety cage 100 indicating that the supply of waste bags provided by the waste bag holder 60 has fallen beneath a predetermined level and/or is entirely depleted. As previously discussed, such a transmission may entail conveying the status data 135 to the server with an indication of the current level of the supply of waste bags remaining and/or an indication of the processor component 150 acting to no longer permit use of the enclosure 15 until the supply is replenished. In response, the processor component 350 may operate the interface 390 to transmit a signal one or more other computing devices to notify personnel of a need to replenish the supply of waste bags at the animal safety cage 100.

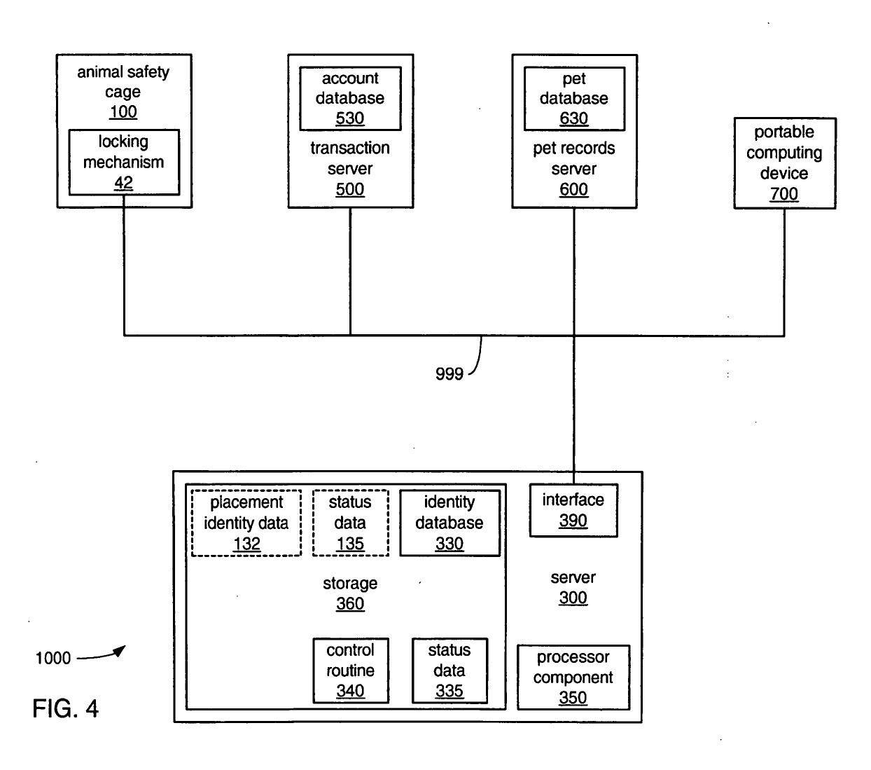

Alternatively or additionally, and referring to FIG. 4, in executing the control routine 340, the processor component 350 monitors the interface 390 for receipt of the placement identity data 132 from the locking mechanism 42. In response to receiving the identity data 132, the processor component 350 performs verification of identifying information in the placement identity data 132, and signals the locking mechanism 42 with an indication of whether or not the identifying information was able to be verified, as has been previously discussed.

In response to the placement of an animal within the enclosure 15, one or both of the processor components 150 and 350 begin monitoring the amount of time that elapses from placement of the animal within the enclosure 15 to retrieval of the animal therefrom. In embodiments in which the identifying information includes a phone number, email address or other contact information enabling the transmission of reminders to the person who placed the animal within the enclosure 15, the processor component 350 may employ such contact information to do so one or more times until the animal is retrieved. To do so, the processor component 350 may operate the interface 390 to transmit such reminders (e.g., emails, text messages, voice-over-Internet-protocol calls, etc.) via the network 999 to a portable computing device 700 that may be carried by the person. In embodiments in which the identifying information includes an account number associated with a chargeable account of the person, the processor 350 may recurringly calculate an amount of a fee to charge to that account that correlates to the amount of time that the animal remains within the enclosure 15. The processor component 350 may operate the interface 390 to signal a transaction server 500 that maintains that account with an amount of the fee to charge to that account.

The transmission of electronic reminders to a portable computing device 700 and/or the charging of fees to an account associated with the person who placed an animal within the enclosure 15 serve to induce that person to not leave that animal in the enclosure for an inordinate amount of time that may be harmful or cruel to that animal. Further, the fact of identifying information of that person having been obtained by the locking mechanism 42 from whatever identifying device(s) 79 serves as an inducement for that person to not inadvertently or deliberately abandon the animal within the enclosure 15, since that identifying information may be used by law enforcement involved in protecting animals to locate that person.

The processor component 350 may recurringly compares the amount of time that elapses since placement of the animal within the enclosure 15 to a predetermined period of time to determine whether sufficient time has elapsed as to regard the animal as having been so abandoned. Alternatively or additionally, the time of day local to the location of the animal safety cage 100 may be taken into account in determining whether the animal has been so abandoned. By way of example, if the animal is still within the enclosure 15 after a time of day at which businesses in the vicinity may be expected to be closed, then the processor component 350 may determine that the animal has been abandoned. In response to determining that the animal has been abandoned, the processor component 350 may transmit an indication to law enforcement personnel providing an indication of the situation, along with identifying information of the person who placed the animal within the enclosure 15.

Presuming that the animal is retrieved from the enclosure 15 within a reasonable period of time, the processor component 350 receives another transmission of the status data 135 indicating such retrieval. In embodiments in which the identifying information includes an account number associated with a chargeable account of the person, the processor 350 may calculate a final amount of a fee to charge to that account that correlates to the amount of time that the animal remained within the enclosure 15, and signal the transaction server 500 to charge that amount to that account.

As also previously discussed, different embodiments of the animal safety cage 100 and/or of the automated kenneling system 1000 may require different predetermined combinations of identifying information to allow an animal to placed within the enclosure 15. Further, the selection of pieces of identifying information for each combination is necessarily related to what identifying devices 79 are required to be provided to the input device(s) 120, is necessarily related to the manner in which verification of identifying information is performed, and is necessarily related to the manner in which a person is induced to retrieve an animal.

By way of example, in a first embodiment, the type of identifying device 79 accepted may be a loyalty card issued to patrons of a business as part of a patron loyalty program. As familiar to those skilled in the art, such loyalty programs often provide discounts to patrons willing to make use of such a loyalty card and willing to agree to having their identifying information, including their name and contact information, known to a business for marketing purposes. Thus, in such an embodiment, the animal safety cage may be configured with an appropriate type of input device 120 able to read a coded number from a loyalty card version of the identifying device 79. Such a loyalty card version of the identifying device 79 may be a physical card carrying a barcode 74 or a magnetic stripe 73 readable by the input device 120.

Alternatively, the loyalty card may be a virtual card generated by a portable computing device 700 carried by a patron. As familiar to those skilled in the art of operation of loyalty programs, a patron may operate the portable computing device 700 to interact with the server 300 to join the loyalty program associated with the animal safety cage 100. In so doing, the patron may download data and/or a routine from the server 300 onto the portable computing device 700 to enable the portable computing device 700 to visually present the barcode 74 on a display of the portable computing device 700. With the barcode 74 so displayed, the portable computing device 700 may be used as a substitute for a physical loyalty card.

The processor component 150 of the locking mechanism 42 may accept a loyalty program identification number from reading a barcode via the input device 120, store the loyalty program identification number as the placement identity data 132, and transmit the placement identity data 132 to the server 300 for verification. In response to receiving the identity data 132, the processor component 350 of the server 300 verifies the loyalty program identification number by checking for it in the identity database 330 to determine whether it is associated with a patron currently participating in the loyalty program. Presuming that the loyalty program identification number is able to be so verified, the processor component 350 signals the locking mechanism 42 via the network 999 to the effect that the loyalty program identification number is verified. In response, the processor component 150 of the locking mechanism 42 operates the bolt actuator 175, the key release 172 and the lock restrictor 177 to allow the person with the loyalty program card (whether physical or virtual) that serves as the identifying device 79 in this embodiment to place an animal within the enclosure 15.

By way of example, in a second embodiment, the type of identifying device 79 accepted may be a credit card and/or an automatic teller machine (ATM) card. As familiar to those skilled in the art, credit cards and ATM cards typically incorporate a magnetic stripe and/or RFID chip on which is stored at least a person's name and an account number associated with that person. Thus, in such an embodiment, the locking mechanism 42 of the animal safety cage may be configured with an appropriate type of input device 120 able to read a person's name and account number from a credit card or ATM card version of the identifying device 79. More specifically, the processor component 150 of the locking mechanism 42 may accept a name and an associated account number from reading a magnetic stripe 73 or RF signals from a RFID chip 75 via the input device 120, store both as the placement identity data 132, and transmit the placement identity data 132 to the server 300 for verification.

In response to receiving the identity data 132 in such an embodiment, the processor component 350 of the server 300 verifies the name and account number by signaling, via the network 999, a transaction server 500 associated with a credit card provider and/or a bank associated with the identifying device 79 to request authorization to charge an amount on the account associated with the account number. As familiar to those skilled in the art, the combination of at least a name and an account number must correspond to each other and to a current account for such authorization to be given. Thus, if the server 300 receives authorization to charge an amount to an account associated with the name and account number, then that combination of name and account number is effectively verified. Presuming that such authorization amounting to such a verification is received from the transaction server 500, the processor component 350 signals the locking mechanism 42 via the network 999 to the effect that the name and account number are verified. In response, the processor component 150 of the locking mechanism 42 operates the bolt actuator 175, the key release 172 and the lock restrictor 177 to allow the person with the credit card or ATM card that serves as the identifying device 79 in this embodiment to place an animal within the enclosure 15.

By way of example, in a third embodiment, the type of identifying device 79 accepted may be a RFID chip embedded into a portion of the body of the animal sought to be placed within the enclosure 15. As familiar to those skilled in the art, so-called “microchipping” of pets, in which a RFID chip that carries an identification code is injected into a portion of the body of a pet (e.g., under the skin between the shoulder blades of a cat or dog), is becoming increasingly popular as a way to increase the likelihood of pets being returned to their owners if they should escape or otherwise be lost. Thus, in such an embodiment, the locking mechanism 42 of the animal safety cage 100 may be configured with an appropriate type of input device 120 able to read a RFID chip of an animal sought to be placed within the enclosure 15. More specifically, the processor component 150 of the locking mechanism 42 may accept an identification code received in RF output from such a RFID chip via the input device 120, store the identification code as the placement identity data 132, and transmit the placement identity data 132 to the server 300 for verification.

In response to receiving the identity data 132 in such an embodiment, the processor component 350 of the server 300 verifies the identification code by signaling, via the network 999, a pet records server 600 that maintains a database correlating such identification codes to names and addresses of pet owners to at least request verification that the identification code is a valid one. If the server 300 receives a name and address in response to providing the identification code to the pet records server 600, then that identification code is effectively verified. Presuming that such an indication of validity of the identification code is received from the pet records server 600, the processor component 350 signals the locking mechanism 42 via the network 999 to the effect that the identification code is verified, and transmits the name and address received from the pet records server 600 to the locking mechanism 42. In response, the processor component 150 of the locking mechanism 42 stores the name and address as part of the placement identity data 132. The processor component 150 also operates the bolt actuator 175, the key release 172 and the lock restrictor 177 to allow the person with the “microchipped” animal to place that animal within the enclosure 15.

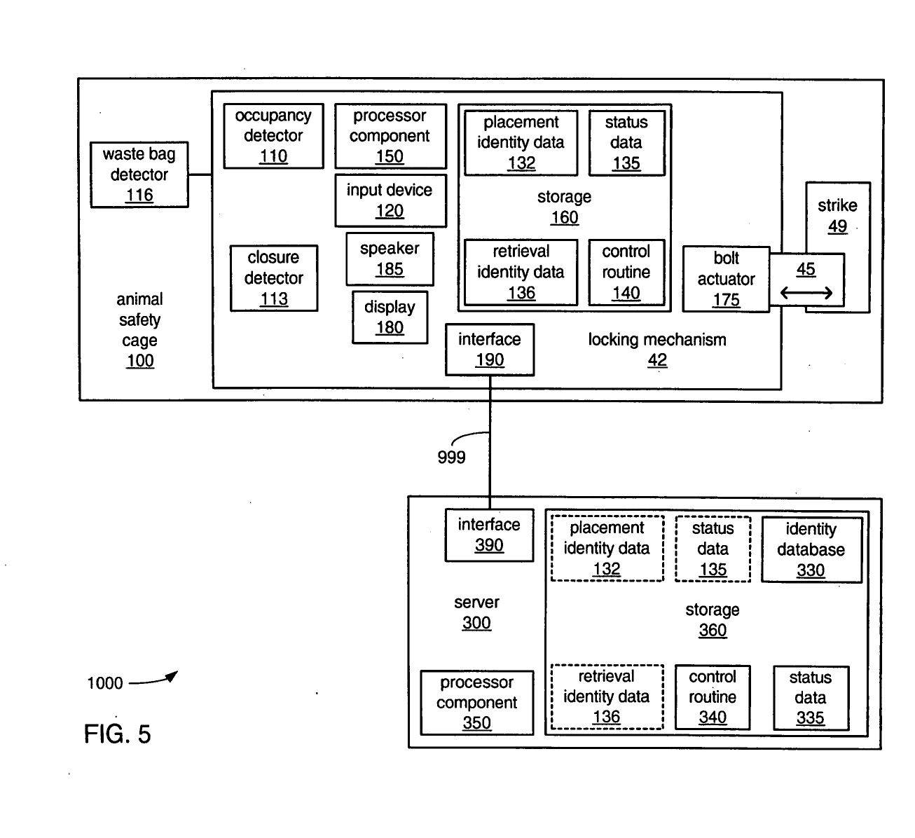

Referring to FIG. 5, alternate embodiments of the animal safety cage 100 and of the automated kenneling system 1000 may not employ the provision of the key 62 to enable a person to retrieve an animal earlier placed within the enclosure 15. Instead, such alternate embodiments may again accept identifying information from one or more identifying devices 79 to verify that the person seeking to retrieve an animal from within the enclosure 15 is the same person who earlier placed that animal within the enclosure 15.

As depicted in FIG. 5, the locking mechanism 42 of such an alternate embodiment of the animal safety cage 100 is substantially similar to the embodiment depicted in FIG. 3. Therefore, similar reference numerals are used between FIGS. 3 and 5 to label corresponding components. However, a significant difference is the omission of the key release 172, the lock restrictor 177 and the key detector 112 from the embodiment of FIG. 5. Another significant difference is the addition of a retrieval identity data 136 to what is stored in the storage 160. Correspondingly, the server 300 of such an alternate embodiment is substantially similar to the embodiment depicted in FIG. 3. However, a significant difference is the addition of the retrieval identity data 136 to what is stored in the storage 360 following its receipt by the server 300 from the locking mechanism 42.

In such an alternate embodiment, instead of inserting the key 62 into the lock cylinder 43 to retrieve an animal from within the enclosure 15, a person again provides identifying information to the locking mechanism 42 by again presenting one or more identifying devices 79 to be read by the input device(s) 120. The processor component 150 monitors the input device(s) 120 for an indication of receipt of identifying information. Upon receiving an indication of at least an attempt to provide identifying information by such a person, the processor component 150 may operate the display 180 and/or the speaker 185 to prompt the person as to what types of identifying devices 79 (or combinations of identifying devices 79) are required.

Upon receiving another predetermined combination of pieces of identifying information from one or more identification devices 79 provided by that person, the processor component 150 stores the identifying information as the retrieval identity data 136. What pieces of identifying information make up the predetermined combination for retrieving an animal is at least partially dictated by what pieces of identifying information made up the predetermined combination for earlier placing that animal in the enclosure 15.

The processor component 150 attempts to verify the identifying information of the retrieval identity data 136 by comparing its identifying information to the identifying information that which was earlier obtained and stored as the placement identity data 132 when the animal was placed within enclosure 15. If the identifying information of the placement identity data 132 and the retrieval identity data 136 are determined to match to at least a predetermined degree, then the processor component 150 operates the bolt actuator 175 to unlock the door 39 to enable retrieval of the animal within the enclosure 15. However, if there is no match or an insufficient match, then the processor component 150 may operate the display 180 and/or the speaker 185 to present an indication to the person that they are denied access to the interior of the enclosure 15 to retrieve the animal therein due to apparently not being the same person who originally placed the animal therein. Alternatively or additionally, the processor component 150 may transmit both the placement identity data 132 and the retrieval identity data 136 to the server 300 to enable the server 300 to attempt to verify the identifying information of the retrieval identity data 136.

By way of example, the person who earlier placed the animal within the enclosure 15 may be the same person who now seeks to retrieve it, but they may have used a different identifying device 79 that has presents identifying information that varies to some degree from the identifying information earlier provided during placement of the animal within the enclosure 15 (e.g., a maiden surname versus a married surname, or an older residential address versus a newer residential address). In response to receiving the placement identity data 132 and the retrieval identity data 136, the processor component 350 may be able to employ identifying information collected in the identity database 330 to resolve such variations in identifying information and transmit an indication to the locking mechanism 42 that the identifying information of the retrieval identity data 136 is verified.

By way of another example, the person who earlier placed the animal within the enclosure 15 may be a different person from the person who now seeks to retrieve it, but these two different people may related in some manner (e.g., relatives of the same family, or co-habitants of the same address). Again, in response to receiving the placement identity data 132 and the retrieval identity data 136, the processor component 350 may be able to employ identifying information collected in the identity database 330 to determine that a close enough relationship exists between the two people to allow retrieval of the animal and transmit an indication to the locking mechanism 42 that the identifying information of the retrieval identity data 136 is verified.

Thus, in such alternate embodiments in which identifying information is employed in retrieving an animal from within the enclosure 15, instead of the key 62, the state of occupancy of the enclosure 15 affects the manner in which verification of identifying information is performed. More specifically, when the enclosure 15 is in an unoccupied state, identifying information received via the input device(s) 120 is relayed to the server 300 for verification. However, when the enclosure 15 is in an occupied state, identifying information received via the input device(s) 120 is at least initially compared to verification information received earlier during placement of the animal within the enclosure 15 for verification. Given this difference in verification techniques depending on the occupancy state of the enclosure 15, the occupancy state can be said to at least partly control the conditions under which the door 39 is unlocked.

The processor components 150 and 350 may include any of a wide variety of commercially available processors. Further, each of these processor components may include multiple processors, a multi-threaded processor, a multi-core processor (whether the multiple cores coexist on the same or separate dies), and/or a multi processor architecture of some other variety by which multiple physically separate processors are in some way linked.

The storages 160 and 360 may be based on any of a wide variety of information storage technologies. Such technologies may include volatile technologies requiring the uninterrupted provision of electric power and/or technologies entailing the use of machine-readable storage media that may or may not be removable. It should be noted that although each of these storages is depicted as a single block, one or more of these may include multiple storage components that may each be based on differing storage technologies. It should also be noted that each of these storages may be made up of multiple storage components based on identical storage technology, but which may be separately operated as a result of specialization in use.

The interfaces 190 and 390 may employ any of a wide variety of signaling technologies enabling coupling to a portion of the network 999, including technologies to support electrical and/or optical cabling, and/or technologies to support radio frequency and/or optical wireless signaling. Each of these interfaces includes circuitry providing at least some of the requisite functionality to enable such coupling, but may also be at least partially implemented with executable sequences of instructions (e.g., to implement a protocol stack or other features).

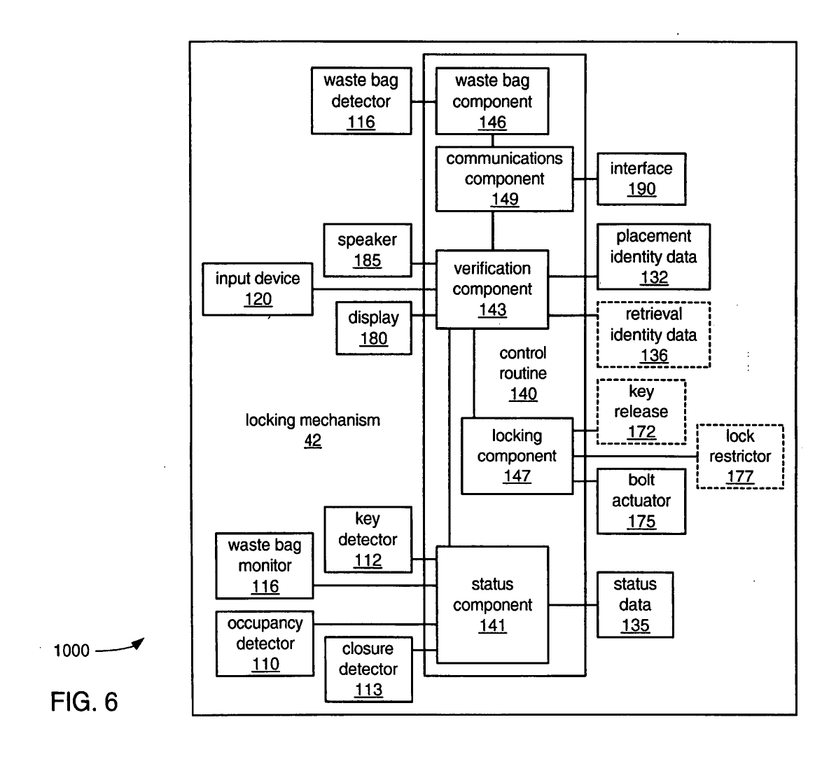

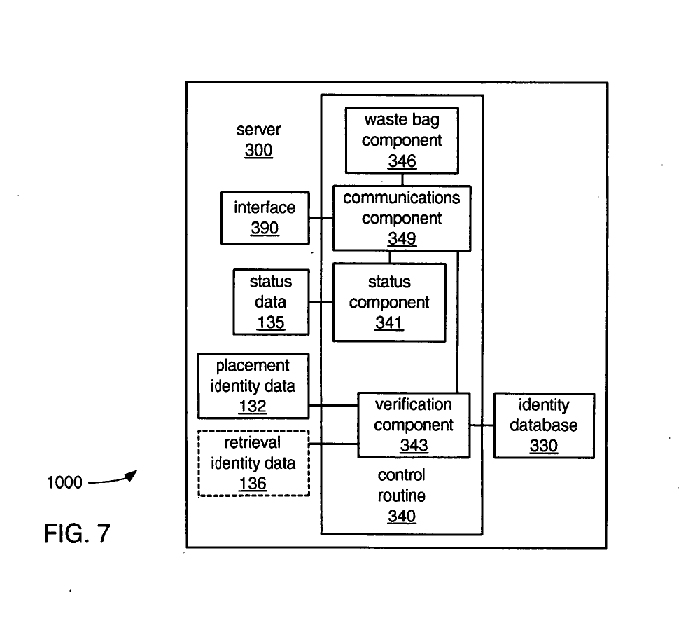

FIGS. 6 and 7 are each a block diagram of a portion of an embodiment of the automated kenneling system 1000 of FIGS. 3, 4 and/or 5 in greater detail. More specifically, FIG. 6 depicts aspects of a possible operating environment of the locking mechanism 42, and FIG. 7 depicts aspects of a possible operating environment of the server 300.

As recognizable to those skilled in the art, the control routines 140 and 340, including the components of which each is composed, are selected to be operative on whatever type of processor or processors that are selected to implement applicable ones of the processor components 150 and 350. Each of the control routines 140 and 340 may include one or more of an operating system, device drivers and/or application-level routines (e.g., so-called “software suites” provided on disc media, or “applets” obtained from a remote server. Where an operating system is included, the operating system may be any of a variety of available operating systems appropriate for whatever corresponding ones of these processor components. Where one or more device drivers are included, those device drivers may provide support for any of a variety of other components, whether hardware or software components, of corresponding ones of the locking mechanism 42 and the server 300.

The application routines 140 and 340 may include a communications component 149 and 349 executable by the processor components 150 and 350 to operate the interfaces 190 and 390, respectively, to transmit and receive signals via the network 999 as has been described. Among the signals received may be signals conveying the placement identity data 132, the status data 35 and/or the retrieval identity data 136 among the locking mechanism 42, the server 300 and/or one or more other computing devices (e.g., the servers 500 or 600, or the portable computing device 700) via the network 999. As recognizable to those skilled in the art, each of these communications components are selected to be operable with whatever type of interface technology is selected to implement corresponding ones of the interfaces 190 and 390.

Turning more specifically to FIG. 6, the control routine 140 may include a waste bag component 146 executable by the processor component 150 to monitor the supply of waste bags provided by the waste bag holder 60. Upon the supply of waste bags diminishing below a predetermined level, the interface 190 may be operated (through the communications component 149) to transmit a signal to personnel indicating the low level of supply. Alternatively or additionally, upon depletion of the supply of waste bags, the interface 190 may be operated to transmit a signal to personnel indicating such depletion. Such signaling of personnel may entail operation of the interface 190 to signal another computing device via the network 999 (e.g., the server 300) to trigger that other computing device to signal personnel. Alternatively or additionally, such signaling of personnel may entail operation of the interface 190 to interact with a wired or wireless communications system (e.g., a portion of the network 999 implemented as a wired telephone network, a voice-over-Internet-protocol network, or a cellular telephone network) to initiate a call to personnel. Further, upon depletion of the supply of waste bags, further use of the animal safety cage 100 to temporarily hold an animal may be halted.

The control routine 140 may include a status component 141 executable by the processor component 150 to monitor the occupancy detector 110, the key detector 112 (if present), the closure detector 113 and/or the waste bag detector 116 to determine whether the enclosure 15 is occupied, whether the key 62 is currently inserted in the lock cylinder 43, whether the door 39 is closed and/or whether the supply of waste bags is low or depleted, respectively. The indications of changes in one or more of these monitored states may be stored as part of the status data 135, and the status data 135 may be recurringly transmitted (through the communications component 149) to another computing device (e.g., the server 300).

The control routine 140 may include a locking component 147 executable by the processor component 150 to operate the bolt actuator 175, the key release 172 (if present) and/or the lock restrictor 177 (if present) to selectively unlock the door 39, release the key 62 to a person and/or prevent operation of the key 62 in the lock cylinder 43 to unlock the door 39, respectively. One or more of these various actions may be taken in response to successful verification of identifying information, placement of an animal within the enclosure 15, retrieval of an animal therefrom, and/or other events as has been described.

The control routine 140 may include a verification component 143 executable by the processor component 150 to receive identifying information via one or more input device(s) 120, act to verify identifying information, provide information to persons via the display 180 and/or the speaker 185, and allow access to the interior of the enclosure 15 to place and/or retrieve an animal (through the locking component 147) in response to successful verification of identifying information. As has been discussed, actions to verify identifying information may include signaling a server (through the communications component 149) with identifying information to enable that server to verify it, and/or directly comparing identifying information received during an effort by a person to retrieve an animal to identifying information received during placement of that animal.

Turning more specifically to FIG. 7, the control routine 340 may include a waste bag component 346 executable by the processor component 350 to receive signals from the locking mechanism 42 of the animal safety cage 100 (via the network 999) indicating that the supply of waste bags provided by the waste bag holder 60 has either fallen below a predetermined level or has been entirely depleted. In response, the interface 390 may be operated to signal personnel of the need to replenish the supply of waste bags. Such signaling of personnel may entail operation of the interface 390 to interact with a wired or wireless communications system (e.g., a portion of the network 999 implemented as a wired telephone network, a voice-over-Internet-protocol network, or a cellular telephone network) to initiate a call to personnel.

The control routine 340 may include a verification component 343 executable by the processor component 350 to receive identifying information from the locking mechanism 42 of the animal safety cage 100 (via the network 999), and to act to verify such identifying information in response. As has been discussed, actions to verify identifying information may include signaling one or more other servers (e.g., the transaction server 500 or the pet records server 600) with identifying information to verify it, and/or directly determining whether associations between pieces of identifying information through use of identifying information maintained in a database (e.g., the identity database 330). Upon either successfully verifying identifying information or failing to do so, the results of the attempt to do so are transmitted back to the locking mechanism 42 of the animal safety cage.

The control routine 340 may include a status component 341 executable by the processor component 350 to receive indications of status of the animal safety cage 100 (in transmissions of the status data 135 via the network 999), and to monitor the elapsing of time during which animals are placed in the enclosure 15. As such time passes and where there is identifying information that includes contact information useable to transmit electronic reminder messages, one or more of such reminder messages may be electronically transmitted to the person who placed the animal within the enclosure 15 to not forget to retrieve that animal. Alternatively or additionally, if the amount of time that passes exceeds a predetermined period of time and/or if the hour of the day in the time zone of the animal safety cage 100 goes beyond a reasonable hour at which business would normally be expected to be open, then law enforcement personnel may be signaled to the effect that an animal within the enclosure 15 appears to have been abandoned there. Such signaling of law enforcement personnel may include the transmission of identifying information sufficient to enable law enforcement personnel to contact the person who placed the animal within the enclosure 15.

As previously discussed, the control routine 140 incorporates a sequence of executable instructions implementing logic, that when executed by the processor component 150, causes the processor component 150 to perform various functions described herein. Similarly, the control routine 340 incorporates a sequence of executable instructions also implementing logic, that when executed by the processor component 350, causes the processor component 350 to perform various functions described herein. However, it should be noted that at least some of the logic implemented by instructions of either or both of the control routines 140 and 340 may alternatively be implemented in a manner that does not entail such use of executable instructions. For example, at least some of such logic may be implemented as “hard-wired” or “in hardware” in various forms, including and not limited to, combinational gate logic, sequential gate logic, transistor logic or relay-based logic. Thus, one or more of the components more depicted and discussed in FIGS. 6 and 7 may be implemented with one or more of such forms of logic not entailing the use of executable instructions.

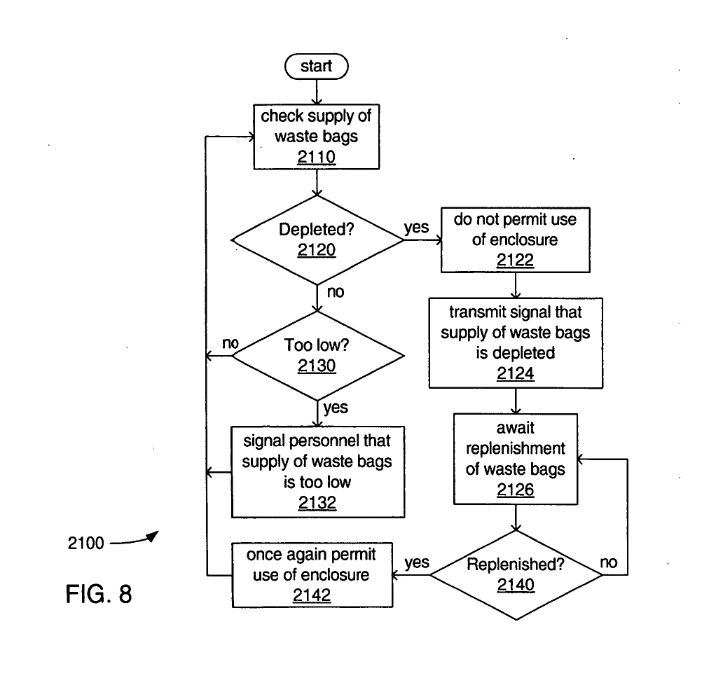

FIG. 8 illustrates a flowchart of logic that may be implemented in one or more embodiments described herein. More specifically, the flowchart 2100 may illustrate operations performed by the processor component 150 in executing at least a portion of the control routine 140, and/or performed by other component(s) of the locking mechanism 42 of the animal safety cage 100.

At 2110, a supply of waste bags provided by a waste bag holder of an animal safety cage (e.g., the waste bag holder 60 of the animal safety cage 100) is checked. If, at 2120, the supply of waste bags is not depleted, then a determination is made at 2130 as to whether the supply of waste bags has been diminished to a level beneath a predetermined level. If, at 2130, the supply of waste bags has not been depleted to such a low level, then the check of the supply of waste bags is repeated at 2110. Otherwise, if, at 2130, the supply of waste bags has been depleted to such a low level, then a signal is transmitted to personnel to indicate that the supply of waste bags is low at 2132. As has been discussed, such signaling of personnel may be accomplished by a component of the animal safety cage (e.g., one or more components of the locking mechanism 42 of the animal safety cage 100) transmitting a signal to a computing device via a network. Such a transmission may entail the sending of an email or a text message to a portable computing device carried by such personnel. Alternatively or additionally, such a transmission may entail initiating a phone call on a wired telephone network, a voice-over-Internet-protocol telephone network and/or a cellular wireless telephone network.

However, if at 2120, the supply of waste bags has been depleted, then further use of the enclosure of the animal safety cage for temporary placement of animals (e.g., the enclosure 15) is disallowed at 2122, and personnel are signaled to the effect that the supply of waste bags has been depleted at 2124. Replenishment of the supply of waste bags is awaited at 2126 with repeated checks of whether replenishment has occurred being made at 2140. If, at 2140, the supply of waste bags is replenished, then use of the enclosure for temporary placement of animals is once again permitted at 2142, and another check of the supply of waste bags is made at 2110.

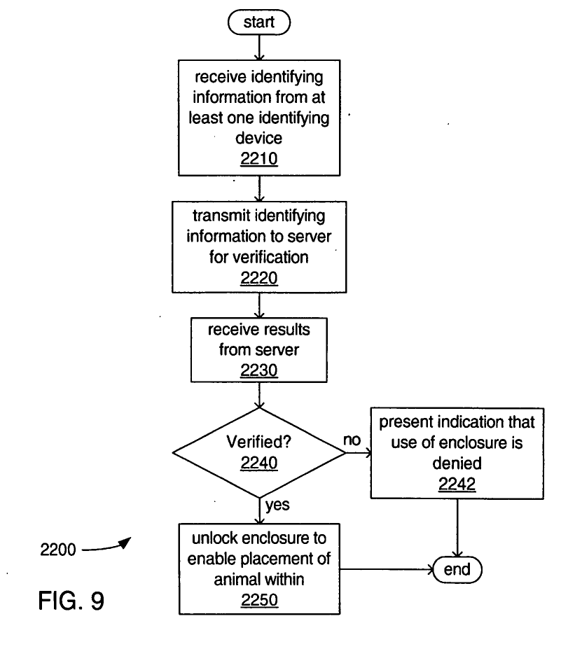

FIG. 9 illustrates a flowchart of logic that may be implemented in one or more embodiments described herein. More specifically, the flowchart 2200 may illustrate operations performed by the processor component 150 in executing at least a portion of the control routine 140, and/or performed by other component(s) of the locking mechanism 42 of the animal safety cage 100.

At 2210, a component of an animal safety cage (e.g., the locking mechanism 42 of the animal safety cage 100) receives identifying information from at least one identifying device (e.g., one of the above examples of the identifying device 79). At 2220, the identifying information is transmitted to a server (e.g., the server 300) for verification, and the results are received from the server at 2230. As has been discussed, the identifying information may include, without limitation, one or more of a name, street address, telephone number, email address, an account number associated with a financial account (e.g., a credit card account or a bank account), or an identification code carried by a RFID chip embedded in a body part of an animal. As has also been discussed, examples of an identifying device include, without limitation, a credit card, an ATM card, a key fob, a loyalty program card, a driver's license, or a virtual card implemented with a portable computing device.

If, at 2240, the identifying information is verified, then the component of the animal safety cage unlocks an enclosure of the animal safety cage (e.g., the enclosure 15) to allow placement of an animal therein at 2250. However, if at 2240, the identifying information is not verified, then the component presents an indication to the person seeking to place the animal within the enclosure that use of the enclosure to do so is denied at 2242.

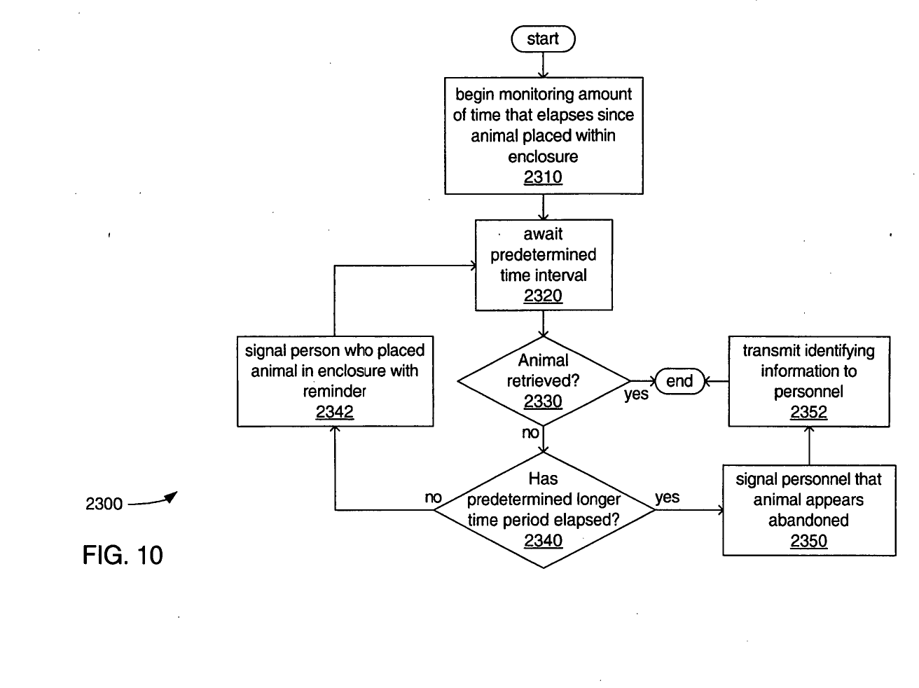

FIG. 10 illustrates a flowchart of logic that may be implemented in one or more embodiments described herein. More specifically, the flowchart 2300 may illustrate operations performed by the processor component 150 or 350 in executing at least a portion of the control routine 140 or 340, and/or performed by other component(s) of the locking mechanism 42 of the animal safety cage 100 or of the server 300, respectively.

At 2310, monitoring begins of an amount of time elapsing since an animal was placed within an enclosure of an animal safety cage (e.g., the enclosure 15 of the animal safety cage 100). At 2320, a predetermined interval is awaited, and a check is made at 2330 as to whether the animal has yet been retrieved following waiting that predetermined interval. If the animal has been retrieved at 2330, then no further action may be taken.

However, if at 2330, the animal has not yet been retrieved, then a check is made at 2340 as to whether a longer predetermined period of time has elapsed since the animal was placed in the enclosure. If that longer predetermined period of time has elapsed, then personnel are signaled at 2350 to the effect that it appears that the animal may have been abandoned in the enclosure, and the identifying information obtained about the person who placed the animal therein at the time they did so is transmitted to those personnel at 2352. As has been discussed, instances in which an animal has been placed in the enclosure for a time longer than a relatively lengthy predetermined period of time may be presumed to be instances of animal abandonment, and personnel such as law enforcement may be automatically signaled about the apparent abandonment. Alternatively or additionally, law enforcement personnel may be signaled with an indication of an apparent animal abandonment where the animal continues to be left in the enclosure beyond an hour of the day at which businesses are presumably closed, even if the amount of time the animal has been within the enclosure is does not exceed such a longer predetermined period of time.

However, if at 2340, the longer predetermined period of time since the animal was placed in the enclosure has not yet elapsed, then the person who so placed the animal within the enclosure is signaled with a reminder at 2342. Alternatively or additionally, where the identifying information includes an account number associated with an account that can be charged a fee for placement of the animal within the enclosure, then such a fee correlated to the amount of time the animal has been left within the enclosure may be charged. As previously discussed, the charging of such a fee may entail a component of the animal safety cage (e.g., the locking mechanism 42 of the animal safety cage 100) signaling a transaction server (e.g., the transaction server 500) to charge the fee to the account associated with that account number.

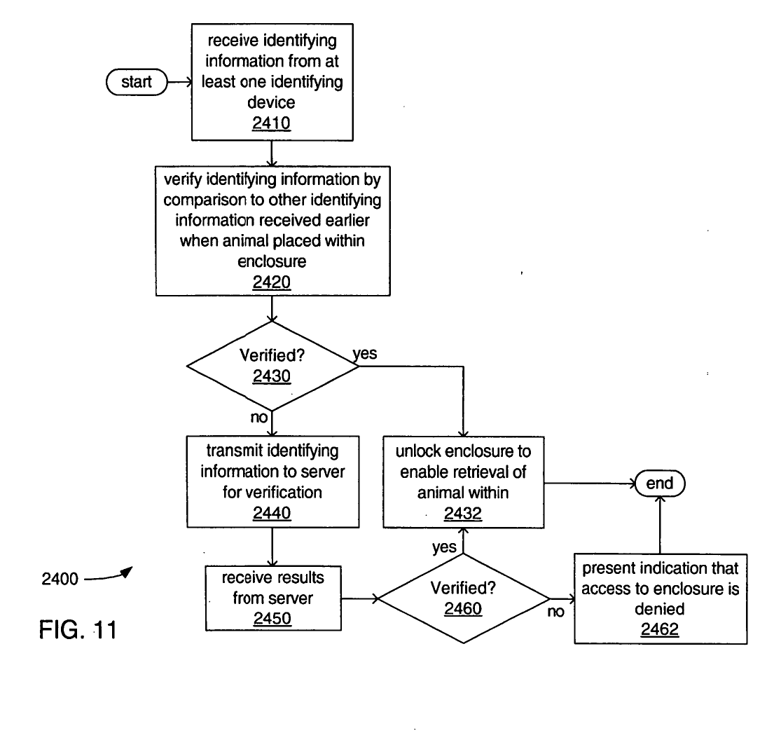

FIG. 11 illustrates a flowchart of logic that may be implemented in one or more embodiments described herein. More specifically, the flowchart 2200 may illustrate operations performed by the processor component 150 in executing at least a portion of the control routine 140, and/or performed by other component(s) of the locking mechanism 42 of the animal safety cage 100.

At 2410, a component of an animal safety cage (e.g., the locking mechanism 42 of the animal safety cage 100) receives identifying information from at least one identifying device (e.g., one of the above examples of the identifying device 79). At 2420, the component attempts to verify the identifying information just received by comparing it to other identifying information received earlier when an animal was placed within an enclosure of the animal safety cage (e.g., the enclosure 15 of the animal safety cage 100).

If, at 2430, the identifying information is verified, then the component of the animal safety cage unlocks the enclosure to allow retrieval of the animal placed within it. However, if at 2430, the identifying information is not verified, then the component transmits the identifying information to a server (e.g., the server 300) to allow the server to attempt to verify it, and receives the results of that attempt at 2450. As has been discussed, the person who originally placed the animal within the enclosure may be the same person who later comes to retrieve the animal. However, they may mistakenly use a different identifying devices when placing the animal within the enclosure and when returning to retrieve the animal, and the identifying information of those different identifying devices may differ to a degree that thwarts verification by a simple comparison therebetween. Alternatively, a person may come to retrieve the animal who is not the same person who originally placed it within the enclosure, but the two persons may be associated in some manner such that the person coming to retrieve the animal should be allowed to do so. In either case, the server may have access to a database of identifying information that may enable differences in identifying information to be resolved and/or associations between two different people to be identified.

If, at 2460, the identifying information is verified, then the enclosure is unlocked at 2432 to allow retrieval of the animal placed within it. However, if the identifying information is not verified at 2460, then the component presents an indication to the person seeking to retrieve the animal within the enclosure that access to the enclosure is denied at 2462.

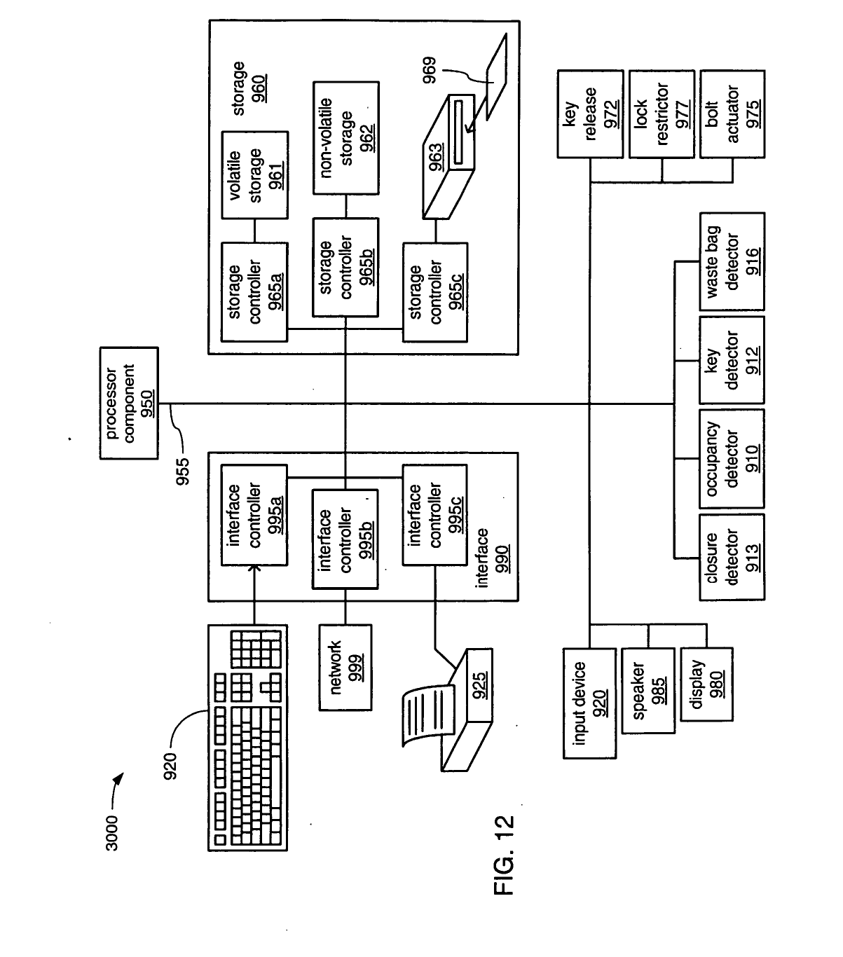

FIG. 12 illustrates an embodiment of a processing architecture 3000 suitable for implementing various embodiments as previously described. More specifically, the processing architecture 3000 may be implemented as part of one or both of the locking mechanism 42 and the server 300. It should be noted that components of the processing architecture 3000 are given reference numbers in which the last two digits correspond to the last two digits of reference numbers of at least some of the components earlier depicted and described as part of these computing devices. This is done as an aid to correlating components of each.

As depicted, in implementing the processing architecture 3000, a computing device includes at least a processor component 950, a storage 960, an interface 990 to other devices, and a coupling 955. As will be explained, depending on various aspects of a computing device implementing the processing architecture 3000, including its intended use and/or conditions of use, such a computing device may further include additional components.

The coupling 955 includes one or more buses, point-to-point interconnects, transceivers, buffers, crosspoint switches, and/or other conductors and/or logic that communicatively couples at least the processor component 950 to the storage 960. The coupling 955 may further couple the processor component 950 to the interface 990 and/or one or more other components. With the processor component 950 being so coupled by the coupling 955, the processor component 950 is able to perform the various ones of the tasks described at length, above, for whichever one(s) of the aforedescribed computing devices implement the processing architecture 3000. The coupling 955 may be implemented with any of a variety of technologies or combinations of technologies by which signals are optically and/or electrically conveyed.

As previously discussed, the processor component 950 (corresponding to the processor components 150 and/or 350) may include any of a wide variety of commercially available processors, employing any of a wide variety of technologies and implemented with one or more cores physically combined in any of a number of ways.

As previously discussed, the storage 960 (corresponding to the storages 160 and/or 360) may be made up of one or more distinct storage devices based on any of a wide variety of technologies or combinations of technologies. More specifically, as depicted, the storage 960 may include one or more of a volatile storage 961 (e.g., solid state storage based on one or more forms of RAM technology), a non-volatile storage 962 (e.g., solid state, ferromagnetic or other storage not requiring a constant provision of electric power to preserve their contents), and a removable media storage 963 (e.g., removable disc or solid state memory card storage by which information may be conveyed between computing devices). This depiction of the storage 960 such that it may include multiple distinct types of storage is in recognition of the commonplace use of more than one type of storage device in computing devices in which one type provides, relatively rapid reading and writing capabilities enabling more rapid manipulation of data by the processor component 950 (but which may use a “volatile” technology constantly requiring electric power) while another type provides relatively high density of non-volatile storage (but likely provides relatively slow reading and writing capabilities).

Given the often different characteristics of different storage devices employing different technologies, it is also commonplace for such different storage devices to be coupled to other portions of a computing device through different storage controllers coupled to their differing storage devices through different interfaces. By way of example, where the volatile storage 961 is present and is based on RAM technology, the volatile storage 961 may be communicatively coupled to coupling 955 through a storage controller 965a providing an appropriate interface to the volatile storage 961 that perhaps employs row and column addressing, and where the storage controller 965a may perform row refreshing and/or other maintenance tasks to aid in preserving information stored within the volatile storage 961. By way of another example, where the non-volatile storage 962 is present and includes one or more ferromagnetic and/or solid-state disk drives, the non-volatile storage 962 may be communicatively coupled to the coupling 955 through a storage controller 965b providing an appropriate interface to the non-volatile storage 962 that perhaps employs addressing of blocks of information and/or of cylinders and sectors. By way of still another example, where the removable media storage 963 is present and includes one or more optical and/or solid-state disk drives employing one or more pieces of machine-readable storage medium 969, the removable media storage 963 may be communicatively coupled to coupling 955 through a storage controller 965c providing an appropriate interface to the removable media storage 963 that perhaps employs addressing of blocks of information, and where the storage controller 965c may coordinate read, erase and write operations in a manner specific to extending the lifespan of the machine-readable storage medium 969.

One or the other of the volatile storage 961 or the non-volatile storage 962 may include an article of manufacture in the form of a machine-readable storage media on which a routine including a sequence of instructions executable by the processor component 950 may be stored, depending on the technologies on which each is based. By way of example, where the non-volatile storage 962 includes ferromagnetic-based disk drives (e.g., so-called “hard drives”), each such disk drive typically employs one or more rotating platters on which a coating of magnetically responsive particles is deposited and magnetically oriented in various patterns to store information, such as a sequence of instructions, in a manner akin to storage medium such as a floppy diskette. By way of another example, the non-volatile storage 962 may be made up of banks of solid-state storage devices to store information, such as sequences of instructions, in a manner akin to a compact flash card. Again, it is commonplace to employ differing types of storage devices in a computing device at different times to store executable routines and/or data. Thus, a routine including a sequence of instructions to be executed by the processor component 950 may initially be stored on the machine-readable storage medium 969, and the removable media storage 963 may be subsequently employed in copying that routine to the non-volatile storage 962 for longer term storage not requiring the continuing presence of the machine-readable storage medium 969 and/or the volatile storage 961 to enable more rapid access by the processor component 950 as that routine is executed.

As previously discussed, the interface 990 (corresponding to the interfaces 190 and/or 390) may employ any of a variety of signaling technologies corresponding to any of a variety of communications technologies that may be employed to communicatively couple a computing device to one or more other devices. Again, one or both of various forms of wired or wireless signaling may be employed to enable the processor component 950 to interact with input/output devices (e.g., the depicted example keyboard 920 or printer 925) and/or other computing devices through a network (e.g., the network 999) or an interconnected set of networks.

In recognition of the often greatly different character of multiple types of signaling and/or protocols that must often be supported by any one computing device, the interface 990 is depicted as including multiple different interface controllers 995a, 995b and 995c. The interface controller 995a may employ any of a variety of types of wired digital serial interface or radio frequency wireless interface to receive serially transmitted messages from user input devices, such as the depicted keyboard 920. The interface controller 995b may employ any of a variety of cabling-based or wireless signaling, timings and/or protocols to access other computing devices through the depicted network 999 (perhaps a network made up of one or more links, smaller networks, or perhaps the Internet). The interface 995c may employ any of a variety of electrically conductive cabling enabling the use of either serial or parallel signal transmission to convey data to the depicted printer 925. Other examples of devices that may be communicatively coupled through one or more interface controllers of the interface 990 include, without limitation, microphones, remote controls, stylus pens, card readers, finger print readers, virtual reality interaction gloves, graphical input tablets, joysticks, other keyboards, retina scanners, the touch input component of touch screens, trackballs, various sensors, a camera or camera array to monitor movement of persons to accept commands and/or data signaled by those persons via gestures and/or facial expressions, laser printers, inkjet printers, mechanical robots, milling machines, etc.

As also depicted, depending on which functions of those described herein are performed by a computing device implementing the processing architecture 3000, such a computing device may incorporate one or more additional components. Further, one or more of those additional components may be made accessible to the processor component 950 either through the coupling 955, or less directly through an interface controller of the interface 950 or a storage controller of the storage 960. More specifically, where the locking mechanism implements the processing architecture 3000, one or more of an occupancy detector 910, a key detector 912, a closure detector 913, a waste bag detector 916, an input device 920, a speaker 985, a display 980, a key release 972, lock restrictor 977 and a bolt actuator 975 may also be incorporated.

The processing architecture 3000 includes various elements commonly employed in digital processing, including without limitation, one or more processors, multi-core processors, co-processors, memory units, chipsets, controllers, peripherals, interfaces, oscillators, timing devices, video cards, audio cards, multimedia input/output (I/O) components, power supplies, etc. As used in this present application, such terms as “system” and “component” are intended to refer to an entity of a computing device in which digital processing is carried out, that entity being hardware, a combination of hardware and software, software, or software in execution. For example, a component can be, but is not limited to being, a process running on a processor component, the processor component itself, a storage device (e.g., a hard disk drive, multiple storage drives in an array, etc.) that may employ an optical and/or magnetic storage medium, an software object, an executable sequence of instructions, a thread of execution, a program, and/or an entire computing device (e.g., an entire computer). By way of illustration, both an application running on a server and the server can be a component. One or more components can reside within a process and/or thread of execution, and a component can be localized on one computing device and/or distributed between two or more computing devices. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to one or more signal lines. A message (including a command, status, address or data message) may be one of such signals or may be a plurality of such signals, and may be transmitted either serially or substantially in parallel through any of a variety of connections and/or interfaces.

With general reference to notations and nomenclature used herein, portions of the detailed description may be presented in terms of program procedures executed on a computer or network of computers. These procedural descriptions and representations are used by those skilled in the art to most effectively convey the substance of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatus may be specially constructed for the required purpose or may include a general purpose computer. The required structure for a variety of these machines will appear from the description given.

1. An animal safety cage comprising:
an enclosure to temporarily retain an animal;
a door movable between a closed state to retain the animal within the enclosure and an open state to enable the animal to be placed within or retrieved from the enclosure; and
a locking mechanism to monitor a state of the enclosure and to selectively lock the door in the closed state based on the state of the enclosure.

2. The animal safety cage of claim 1, the enclosure comprising:
a roof to protect the animal from rain; and
a ventilated wall to enable ventilating airflow therethrough.

3. The animal safety cage of claim 1, comprising:
a waste bag holder disposed within the enclosure and dispensing a supply of waste bags;
a waste bag detector to monitor a state of the supply of waste bags within the enclosure; and
an occupancy detector to detect a state of occupancy of the enclosure by the animal, the state of the enclosure comprising the state of the supply of waste bags within the enclosure and the state of occupancy of the enclosure.

4. The animal safety cage of claim 1, comprising:
a processor component;
an interface to couple the processor component to a network; and
a waste bag detector to monitor a state of a supply of waste bags and to transmit a signal to the network via the interface indicating the state of the supply of waste bags falling below a predetermined level, the state of the enclosure comprising the state of the supply of waste bags.

5. The animal safety cage of claim 1, comprising:
a processor component;
an interface to couple the processor component to a network; and
an occupancy detector to monitor a state of occupancy of the enclosure by the animal and to transmit a signal to the network via the interface indicating a change in the state of occupancy, the state of the enclosure comprising the state of occupancy.

6. The animal safety cage of claim 1, the locking mechanism comprising:
a strike mounted on one of the enclosure and the door;
a housing unit mounted on another of the enclosure and the door;
a bolt at least partly disposed within the housing unit and at least partly moveable into and out of the housing unit to selectively engage the strike to lock the door, the bolt biased towards extending out of the housing unit and into engagement with the strike by a spring; and
a bolt actuator to selectively retract the bolt into the housing unit based on the state of the enclosure.

7. An animal safety cage comprising:
an enclosure to temporarily retain an animal;
a door movable between a closed state to retain the animal within the enclosure and an open state to enable the animal to be placed within or retrieved from the enclosure; and
a locking mechanism to accept and attempt verification of identifying information provided by a person associated with the animal, and to selectively lock the door in the closed state based on the verification.

8. The animal safety cage of claim 7, the locking mechanism comprising:
a strike mounted on one of the enclosure and the door;
a housing unit mounted on another of the enclosure and the door;
a bolt at least partly disposed within the housing unit and at least partly moveable into and out of the housing unit to selectively engage the strike to lock the door, the bolt biased towards extending out of the housing unit and into engagement with the strike by a spring; and
a bolt actuator to selectively retract the bolt into the housing unit based on the state of the enclosure.

9. The animal safety cage of claim 7, comprising:
a processor component;
an input device to read the identifying information from an identifying device;
a verification component for execution by the processor component to receive the identifying information through the input device and attempt verification of the identifying information; and
a locking component for execution by the processor component to selectively lock the door in the closed state based on the verification.

10. The animal safety cage of claim 9, comprising:
a lock cylinder to accept a key to operate the lock cylinder to unlock the door; and
a key release to selectively retain the key within the lock cylinder, the locking component to operate the key release to release the key based on the verification.

11. The animal safety cage of claim 10, comprising a lock restrictor to selectively enable the lock cylinder to be operated by the key to unlock the door, the locking component to operate the lock restrictor to enable the lock cylinder to be operated by the key to unlock the door based on the verification.

12. The animal safety cage of claim 9, comprising:
an interface to couple the processor component to a network;
an occupancy detector to detect a state of occupancy of the enclosure by the animal; and
a status component for execution by the processor component to monitor the state of occupancy and transmit a signal to a server via the network indicating a change in the state of occupancy.

13. The animal safety cage of claim 12, the verification component to attempt verification of the identifying information by transmitting the identifying information to the server via the network or by comparing the identifying information to other identifying information earlier read via the input device based on the state of occupancy.

14. An apparatus comprising:
a processor component;
an interface to couple the processor component to a network;
a verification component for execution by the processor component to receive identifying information of a person from an animal safety cage via the network, to attempt verification of the identifying information, and to transmit a result of the verification to the animal safety cage via the network; and
a status component for execution by the processor component to receive an indication of a change in state of occupancy of an enclosure of the animal safety cage by an animal, and to monitor the elapsing of time since receipt of an indication of a start of an occupied state of the enclosure.

15. The apparatus of claim 14, the verification component to attempt verification of the identifying information by transmitting the identifying information and an indication of an amount to charge to an account associated with an account number of the identifying information to a transaction server via the network, and to receive an indication from the transaction server of whether the amount is successfully charged.

16. The apparatus of claim 14, the verification component to attempt verification of the identifying information by transmitting the identifying information to a pet records server via the network, and determine whether the pet records server provides a name and contact information in response, the identifying information comprising an identification code read from a RFID chip embedded in a body portion of the animal.

17. The apparatus of claim 14, the status component to employ contact information of the identifying information to transmit a signal to a portable computing device associated with the person or to signal a transaction server to charge a fee to a financial account associated with the person in response to the elapsing of a first predetermined period of time since the receipt of the indication of the start of the occupied state and a lack of receipt of an indication of an end of the occupied state.

18. The apparatus of claim 17, the status component to employ contact information of the identifying information to signal law enforcement personnel of an apparent abandonment of the animal within the enclosure in response to the elapsing of a second predetermined period of time since the receipt of the indication of the start of the occupied state and a lack of receipt of an indication of an end of the occupied state, the second predetermined period of time longer than the first predetermined period of time.

19. A computer-implemented method comprising:
monitoring an input device of an animal safety cage to read identifying information from an identifying device;
attempting verification of the identifying information; and
operating a bolt actuator of the animal safety cage to selectively lock a door of an enclosure of the animal safety cage in a closed state based on the verification.

20. The computer-implemented method comprising of claim 19, comprising selectively operating a key release of the animal safety cage to retain a key within a lock cylinder of the animal safety cage based on the verification.

21. The computer-implemented method comprising of claim 20, comprising selectively operating a lock restrictor of the animal safety cage to enable the lock cylinder to be operated by the key to unlock the door based on the verification.

22. The computer-implemented method comprising of claim 19, comprising:
monitoring an occupancy detector of the animal safety cage to detect a state of occupancy of the enclosure by the animal; and
transmitting a signal to a server via a network indicating a change in the state of occupancy.

23. The computer-implemented method comprising of claim 22, comprising attempting verification of the identifying information by transmitting the identifying information to the server via the network or by comparing the identifying information to other identifying information earlier read via the input device based on the state of occupancy.

24. The computer-implemented method comprising of claim 19, comprising:
attempting verification of the identifying information by transmitting the identifying information and an indication of an amount to charge to an account associated with an account number of the identifying information to a transaction server via the network; and
receiving an indication from the transaction server of whether the amount is successfully charged.

25. The computer-implemented method comprising of claim 19, comprising:
attempting verification of the identifying information by transmitting the identifying information to a pet records server via the network, the identifying information comprising an identification code read from a RFID chip embedded in a body portion of the animal; and
determining whether the pet records server provides a name and contact information in response.

26. The computer-implemented method comprising of claim 19, comprising employing contact information of the identifying information to transmit a signal to a portable computing device associated with the person or to signal a transaction server to charge a fee to a financial account associated with the person in response to the elapsing of a first predetermined period of time since the receipt of the indication of the start of the occupied state and a lack of receipt of an indication of an end of the occupied state.

27. The computer-implemented method comprising of claim 26, comprising employing contact information of the identifying information to signal law enforcement personnel of an apparent abandonment of the animal within the enclosure in response to the elapsing of a second predetermined period of time since the receipt of the indication of the start of the occupied state and a lack of receipt of an indication of an end of the occupied state, the second predetermined period of time longer than the first predetermined period of time.

28. At least one machine-readable storage medium comprising instructions that when executed by a processor component, cause the processor component to:
monitor an input device of an animal safety cage to read identifying information from an identifying device;
attempt verification of the identifying information; and
operate a bolt actuator of the animal safety cage to selectively lock a door of an enclosure of the animal safety cage in a closed state based on the verification.

29. The at least one machine-readable storage medium of claim 28, the processor component caused to:
monitor an occupancy detector of the animal safety cage to detect a state of occupancy of the enclosure by the animal; and
transmit a signal to a server via a network indicating a change in the state of occupancy.

30. The at least one machine-readable storage medium of claim 29, the processor component caused to attempt verification of the identifying information by transmitting the identifying information to the server via the network or by comparing the identifying information to other identifying information earlier read via the input device based on the state of occupancy.

31. The at least one machine-readable storage medium of claim 28, the processor component caused to:
attempt verification of the identifying information by transmitting the identifying information and an indication of an amount to charge to an account associated with an account number of the identifying information to a transaction server via the network; and receive an indication from the transaction server of whether the amount is successfully charged.

32. The at least one machine-readable storage medium of claim 28, the processor component caused to employ contact information of the identifying information to transmit a signal to a portable computing device associated with the person or to signal a transaction server to charge a fee to a financial account associated with the person in response to the elapsing of a first predetermined period of time since the receipt of the indication of the start of the occupied state and a lack of receipt of an indication of an end of the occupied state.
